(19) United States
(12) Patent Application Publication
(10) Pub. No.: US 2008/0270184 A1
(43) Pub. Date: Oct. 30, 2008

(54) ACUTE CARE HEALTH CLINIC

(76) Inventors: Peter Neil Beeckel, Turner, ME (US); Michael Alan Bergeron, Durham, ME (US)

Correspondence Address: HOWARD M COHN;PATENT ATTORNEY LLC, 21625 CHAGRIN BLVD #220, CLEVELAND, OH, 44122, US

(21) Appl. No.: 12/110,949

(22) Filed: Apr. 28, 2008

Related U.S. Application Data
(60) Provisional application No. 60/914,355, filed on Apr. 27, 2007.

(51) Int. Cl. G06Q 10/00

(52) U.S. Cl. 705/2

(57) ABSTRACT

A method for processing patients who visit a health clinic for medical attention. The method comprises maintaining a database of evidence-based medical information based on medical standards and sound clinical judgment with ongoing quality review and improvement that is accessible to a computer system; registering a patient for an appointment at the clinic with the computer system; putting the patient into a clinic queue for receiving medical treatment upon their arriving and registering at the clinic; determining the type of medical treatment required by the patient; administering medical treatment to the patient based on the medical condition of the patient; creating a medical record for the patient including information provided by the patient, information accessed from the database about the patient, and the medical treatment administered during the visit to the patient; and accepting financial payment from the patient.

### CROSS-REFERENCE TO RELATED APPLICATIONS

This application claims priority to U.S. Provisional Patent Application Ser. No. 60/914,355, entitled “Acute Care Retail Health Clinic” filed Apr. 27, 2007, the disclosure of which is hereby expressly incorporated herein by reference.

### FIELD OF THE INVENTION

The present invention relates generally to managing an acute health care center, and more particularly to a user interface adapted interact with an electronic health care system.

### BACKGROUND OF THE INVENTION

A clinic or outpatient clinic is a small medical facility that provides health care for ambulatory patients, as opposed to inpatients treated in a hospital. While most clinics are run by one or more general practitioners, there are clinics operated by private corporations, government organizations or hospitals. The function of clinics will differ from place to place. For instance, a local general practice run by a single general practitioner will provide primary health care and will usually be run as a for-profit business by the owner whereas a government specialist clinic may provide subsidized specialized health care.

Some clinics function as a place for people with injuries or illnesses to come and be seen by medical professionals. In these clinics, the injury or illness is not serious enough to warrant a visit to an emergency room. Treatment at these clinics is often much less expensive than it would be at an emergency room. Also, unlike an emergency room, these clinics are not often open on an around-the-clock basis. These clinics often have access to diagnostic equipment, such as X-ray machines, especially if the clinic is part of a larger facility. Doctors at such clinics can often refer patients to specialists if the need arises.

Presently, electronic medical record and practice management information systems store, retrieve and deliver information to a health care center. Some systems address only one type in of information necessary for clinical and practice management, such as for example, medical records information and billing information records. These prior art systems feature single user interfaces, each allowing entry of only one limited type of information, and are combined with a single data repository that is also limited. The data repositories of these systems usually include duplicate information and are often difficult to interface with each other.

Other prior art systems allow several user interfaces to access a single data repository; however the plurality of user interfaces can be dissimilar in operation and appearance. These types of complicated systems are more difficult for untrained users because of the variety of applications with unrelated user interfaces. In addition, these types of systems often limit the users' ability to move freely within one application requiring, for example, that users complete a specified task before moving on to another.

The systems mentioned require complicated deployment of multiple user interfaces and/or data repositories to different system users and access terminals throughout the health care facility. Health care facilities utilizing such systems risk non-compliance with health care regulations and best practice guidelines, due to the poor connectivity between the multiple interfaced applications with security records and alert systems.

Further, the health care facilities can have higher administrative overhead created by the poor communication between the multiple interfaced applications. For example, poor or nonexistent clinical decision support, or billing applications that contradict diagnostic decisions already filed in the enterprise's medical records application.

### SUMMARY OF THE INVENTION

According to the present invention, there is disclosed a method for processing patients who visit a health clinic for medical attention. The method comprises the steps of: maintaining a database of evidence-based medical information based on medical standards and sound clinical judgment with ongoing quality review and improvement that is accessible to a computer system; registering a patient for an appointment at the clinic with the computer system; putting the patient into a clinic queue for receiving medical treatment upon their arriving and registering at the clinic; determining the type of medical treatment required by the patient; administering medical treatment to the patient based on the medical condition of the patient; creating a medical record for the patient including information provided by the patient, information accessed from the database about the patient, and the medical treatment administered during the visit to the patient; and accepting financial payment from the patient.

Also according to the present invention, the method includes the steps of dispensing medications to the patient; and recording the medications dispensed into the medical record of the patient.

Further according to the present invention, the method includes the steps of registering the patient for an appointment when the patient initiates an open access visit by walking in to the health clinic and positioning the patient of an open access visit in the clinic queue when the patient registers for the appointment.

Still further according to the present invention, the method includes the step of registering the patient for an appointment through an interactive website which communicates in real-time with the computer system. The system includes the step of viewing the clinic queue both remotely and in real time.

Yet further according to the present invention, the method includes the step of controlling administrative functions of the clinic comprising supply ordering, payroll management, bill payment, accounting, and data analysis with the computer system. The method also includes loading information relevant to a patient's medical care and accounting into the database whenever a patient registers for an appointment. Also the method includes the steps of providing a security system for accessing the computer system including: accessing medical records by repeat clinic users with their fingerprints; and securing the clinic records in the computer system.

Also according to the present invention, the method includes the steps of accepting financial payment from the patient includes accepting financial payment for medical services with cash, debit card, credit card, or personal check. The step of accepting financial payment allows submission of office receipts by patients to their insurance carriers.

Further according to the present invention, the method includes the steps of controlling all aspects of the health clinic functioning with the computer system. The controlling step includes setting up appointments based on information from an interactive website; setting up appointments for walk in patients; providing information submitted by the patient to the health clinic medical provider; documenting medications prescribed and provided to patients; checking out patients from the clinic; transmitting records generated during the visit to patient's primary care provider (PCP); and controlling administrative functions.

According to the present invention, an article comprising a machine readable medium having embodied thereon a program is provided. The program is executable by a machine to process patients who visit a health clinic for medical attention by maintaining a database of evidence-based medical information based on medical standards and sound clinical judgment with ongoing quality review and improvement that is accessible to a computer system; registering a patient for an appointment at the clinic with the computer system; putting the patient into a clinic queue for receiving medical treatment upon their arriving and registering at the clinic; determining the type of medical treatment required by the patient; administering medical treatment to the patient based on the medical condition of the patient; creating a medical record for the patient including information provided by the patient, information accessed from the database about the patient, and the medical treatment administered during the visit to the patient; and accepting financial payment from the patient.

Further according to the present invention, the machine readable medium has embodied thereon a program executable by a machine for dispensing medications to the patient; and recording the medications dispensed into the medical record of the patient.

Yet further according to the present invention, the machine readable has embodied thereon a program executable by a machine for registering the patient for an appointment when the patient initiates an open access visit by walking in to the health clinic.

Still further according to the present invention, the machine readable has embodied thereon a program executable by a machine for registering the patient for an appointment through an interactive website which communicates in real-time with the computer system.

Moreover according to the present invention, the machine readable has embodied thereon a program executable by a machine for controlling administrative functions of the clinic comprising supply ordering, payroll management, bill payment, accounting, and data analysis with the computer system.

Further according to the present invention, the machine readable has embodied thereon a program executable by a machine for loading information relevant to a patient's medical care and accounting into the database whenever a patient registers for an appointment.

Still further according to the present invention, the machine readable has embodied thereon a program executable by a machine for controlling all aspects of the health clinic functioning including: setting up appointments for patients based on information from an interactive website; setting up appointments for walk in patients; providing information submitted by the patients to the health clinic medical provider; documenting medications prescribed and provided to the patients; checking out patients from the clinic; transmitting records generated during the visit to the patient's primary care provider (PCP); and controlling administrative functions of the clinic.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

Elements of the figures may (or may not) be numbered as follows. The most significant digits (hundreds) of the reference number correspond to the figure number. For example, elements of FIG. 1 are typically numbered in the range of 100-199, and elements of FIG. 2 are typically numbered in the range of 200-299. Similar elements throughout the figures may be referred to by similar reference numerals. For example, the element 199 in FIG. 1 may be similar (and possibly identical) to the element 299 in FIG. 2. Throughout the figures, each of a plurality of elements 199 may be referred to individually as 199a, 199b, 199c, etc. Such relationships, if any, between similar elements in the same or different figures will become apparent throughout the specification, including, if applicable, in the claims and abstract.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a flow chart of a series of steps, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps and materials are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

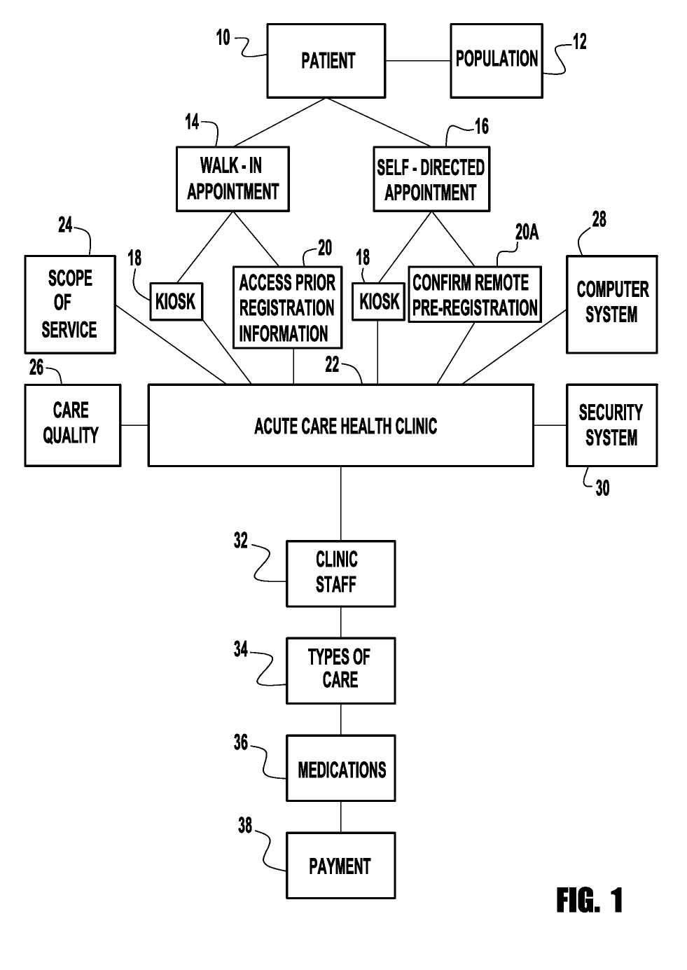

FIG. 1 illustrates a flow chart of the steps incorporated in the present invention.

Box 10 represents a patient who wishes to visit the acute health care clinic of the present invention, as described below, for medical attention.

Box 12 represents the population of patients who would be interested in visiting this type of clinic. These patients are typically either uninsured, underinsured, have a high co-pay or are insured individuals who desire affordable, easy access to medical attention when the latter is not available through their normal provider and as an alternative to an emergency room.

Referring to FIG. 1, patients are treated at an acute care health clinic 22 using a first come first serve, open-access model where patients are treated when they arrive. The patient 10 from population 12 has two options for initiating a visit.

Box 14 represents the first option where the patient simply walks into the clinic 22 to initiate an open access visit. There are two options under this circumstance for the walk in patient to register and check in to receive medical care.

In one option, as indicated by Box 18, the patient walking into the clinic 22 can register with a consumer friendly, conventional interactive touch screen kiosk 18 at the time of the walk-in. During the registration, the patient can provide information such as their previous health conditions, their primary care physician, their primary pharmacy, the symptoms of their medical concern, insurance information and contact information.

Box 20 represents a second option for a walk-in patient to register and check in. That is, they can access information securely stored on computer system 28 from a previous visit so that only their present medical condition and any changes to their stored data can be made on the touch screen kiosk 20. With either of the latter two options, on-line or live assistance is available for registration as needed.

Box 16 represents the case where the patient pre-registers for an appointment through an interactive website which communicates in real-time with the computer system 28. In this case, when the patient enters the Health Clinic, they can check in on kiosk 18. The information from the preregistration indicated at Block 20a will then be brought up on the screen of the kiosk for confirmation. In addition, the patient can key in the symptoms of their medical concern and any change to the previously stored data. Here again, on-line or live assistance is available as needed.

Once the patient is at the clinic to receive medical care, it is expected that the wait time to be seen will typically be fifteen minutes or less, unless it is a busy period.

Box 22 represents the acute care clinic itself. The Acute Care Health Clinic which provides affordable, convenient walk-in acute health care is planned to operate weekdays, weekends, most holidays, and extended evening hours.

Box 24 represents the scope of service typically provided by the clinic. This includes health care to address acute medical conditions, including, but not limited to allergies, neurological, musculoskeletal, urinary, dermatologic, etc.

Box 26 represents the care quality of the clinic, which utilizes evidence-based medical information based on medical standards and sound clinical judgment with ongoing quality review and improvement. This information can be stored on a database accessible by the computer system 28 and available to a health care provider along with the information accessed for each patient.

Box 28 represents the computer system of the clinic. The computer system 28 may include, without limitation, various hardware resources (e.g., servers, computer peripherals, etc.), or even software resources (e.g., application programs and the like) or any combination thereof. The synchronization of the access to the hardware resources 10 may be done simultaneously for the software resources.

The computer system 28 is a comprehensive and integrated system which controls and coordinates all aspects of clinic functioning including but not limited to computer system, the controlling step including: setting up appointments based on information from an interactive website; setting up appointments for walk in patients; providing information submitted by the patient to the health clinic medical provider; documenting medications prescribed and provided to patients; checking out patients from the clinic; transmitting records generated during the visit to patient's primary care provider (PCP); and controlling administrative functions.

The computer system 28 can have embodied thereon a program executable by a machine for controlling administrative functions of the clinic comprising supply ordering, payroll management, bill payment, accounting, and data analysis with the computer system.

Whenever a patient enters the system, information relevant to their medical care and accounting is loaded into the computer system to be accessed as necessary.

Box 30 represents the security system maintained by the clinic for accessing the computer system. The security system includes a program executable by a machine for accessing medical records by repeat clinic users with their fingerprints; and securing the clinic records in the computer system. The security system incorporates software to provide accepted methods of confidentiality and security.

Box 32 represents the next step the patient takes, after arriving and registering at the clinic in which they interact with clinic staff. The staff consists of the providers, which can be family physicians (MDs and DOs), nurse practitioners, and physician assistants. General oversight of the patents is provided by licensed and credentialed Family Physicians, both MD and DO, with regular chart review.

Box 34 represents types of care the clinic performs when treating a patient. The clinic may perform Ancillary Testing, which are (CLIA)-waived tests including, but are not limited to strep tests, urinalyses, influenza tests, pregnancy tests, etc. The clinic may provide adjunctive therapies, such as nebulized therapy and oxygen. The type of care required by each patient can be initially suggested by the symptoms entered by the patient into the computer system at the time of registration. It is planned for the clinic to refer patients requiring chronic care to local PCP's.

Box 36 represents the medications offered by the clinic. In operation, there is on site, point of service dispensing of prepackaged medications, both prescription and over the counter (OTC) with a full course of treatment, which are electronically entered into the patent's medical record and logged. The patient will automatically receive patient education sheets for the prescriptions and general care. The computer system will record the medications dispensed into the medical record of the patient.

Box 38 represents the means of financial payment by the patient. The clinic will accept financial payment for the medical services with cash, debit, credit card, or check. The clinic may be credentialed and registered with applicable insurance companies, depending upon insurance company policies, so as to allow submission of office receipts by patients to their insurance carriers.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for processing patients who visit a health clinic for medical attention, comprising:
maintaining a database of evidence-based medical information based on medical standards and sound clinical judgment with ongoing quality review and improvement that is accessible to a computer system;
registering a patient for an appointment at the clinic with the computer system;
putting the patient into a clinic queue for receiving medical treatment upon their arriving and registering at the clinic;
determining the type of medical treatment required by the patient;
administering medical treatment to the patient based on the medical condition of the patient;
creating a medical record for the patient including information provided by the patient, information accessed from the database about the patient, and the medical treatment administered during the visit to the patient; and
accepting financial payment from the patient.

2. The method of claim 1 including:
dispensing medications to the patient; and
recording the medications dispensed into the medical record of the patient.

3. The method of claim 1 including registering the patient for an appointment when the patient initiates an open access visit by walking in to the health clinic.

4. The method of claim 3 including the positioning the patient of an open access visit in the clinic queue when the patient registers for the appointment.

5. The method of claim 1 including registering the patient for an appointment through an interactive website which communicates in real-time with the computer system.

6. The method of claim 1 including viewing the clinic queue both remotely and in real time.

7. The method of claim 1 including controlling administrative functions of the clinic comprising supply ordering, payroll management, bill payment, accounting, and data analysis with the computer system.

8. The method of claim 1 including loading information relevant to a patient's medical care and accounting into the database whenever a patient registers for an appointment.

9. The method of claim 1 including providing a security system for accessing the computer system including:
accessing medical records by repeat clinic users with their fingerprints; and
securing the clinic records in the computer system.

10. The method of claim 1 including making an initial evaluation of the types of medical care required by each patient based on the symptoms entered by the patient into the computer system at the time of registration.

11. The method of claim 1 wherein the step of accepting financial payment from the patient includes accepting financial payment for medical services with cash, debit card, credit card, or personal check.

12. The method of claim 1 wherein the step of accepting financial payment allows submission of office receipts by patients to their insurance carriers.

13. The method of claim 1 including controlling all aspects of the health clinic functioning with the computer system, the controlling step including:
setting up appointments based on information from an interactive website;
setting up appointments for walk in patients;
providing information submitted by the patient to the health clinic medical provider;
documenting medications prescribed and provided to patients;
checking out patients from the clinic;
transmitting records generated during the visit to patient's primary care provider (PCP); and
controlling administrative functions.

14. An article comprising a machine readable medium having embodied thereon a program, the program being executable by a machine to process patients who visit a health clinic for medical attention by performing:
maintaining a database of evidence-based medical information based on medical standards and sound clinical judgment with ongoing quality review and improvement that is accessible to a computer system;
registering a patient for an appointment at the clinic with the computer system;
putting the patient into a clinic queue for receiving medical treatment upon their arriving and registering at the clinic;
determining the type of medical treatment required by the patient;
administering medical treatment to the patient based on the medical condition of the patient;
creating a medical record for the patient including information provided by the patient, information accessed from the database about the patient, and the medical treatment administered during the visit to the patient; and
accepting financial payment from the patient.

15. The machine readable medium of claim 14 having embodied thereon a program executable by a machine for:
dispensing medications to the patient; and
recording the medications dispensed into the medical record of the patient.

16. The machine readable medium of claim 14 having embodied thereon a program executable by a machine for registering the patient for an appointment when the patient initiates an open access visit by walking in to the health clinic.

17. The machine readable medium of claim 14 having embodied thereon a program executable by a machine for registering the patient for an appointment through an interactive website which communicates in real-time with the computer system.

18. The machine readable medium of claim 14 having embodied thereon a program executable by a machine for controlling administrative functions of the clinic comprising supply ordering, payroll management, bill payment, accounting, and data analysis with the computer system.

19. The machine readable medium of claim 14 having embodied thereon a program executable by a machine for loading information relevant to a patient's medical care and accounting into the database whenever a patient registers for an appointment.

20. The machine readable medium of claim 14 having embodied thereon a program executable by a machine for controlling all aspects of the health clinic functioning including:
setting up appointments for patients based on information from an interactive website;
setting up appointments for walk in patients;
providing information submitted by the patients to the health clinic medical provider;
documenting medications prescribed and provided to the patients;
checking out patients from the clinic;
transmitting records generated during the visit to the patient's primary care provider (PCP); and
controlling administrative functions of the clinic.
